(19) United States
(12) Patent Application Publication
(10) Pub. No.: US 2024/0052070 A1
(43) Pub. Date: Feb. 15, 2024

(54) SONICATION OF CATALYST IN THE PRODUCTION OF AN ISOOLEFIN HOMOPOLYMER

(71) Applicant: ARLANXEO SINGAPORE PTE. LTD., Singapore (SG)

(72) Inventors: Jeremy BOURQUE, Brights Grove (CA); Gregory J. E. DAVIDSON, London (CA); Kuruppu JAYATISSA, London (CA)

(21) Appl. No.: 18/267,350

(22) PCT Filed: Dec. 14, 2021
(86) PCT No.: PCT/CA2021/051802

§ 371 Date: Jun. 14, 2023

(30) Foreign Application Priority Data
Dec. 18, 2020 (EP) 20215406.8

(51) Int. Cl. C08F 2/56; C08F 2/06; C08F 4/14; C08F 110/10

(52) U.S. Cl. CPC C08F 2/56; C08F 2/06; C08F 4/14; C08F 110/10

(57) ABSTRACT

A process for producing an isoolefin homopolymer comprises: sonicating a solution of an initiator system in an organic solvent, the initiator system comprising a Lewis acid catalyst and a proton source selected from the group consisting of water, an alcohol, a phenol, a thiol, a carboxylic acid or any mixture thereof, to produce a sonicated initiator solution, the sonicating performed at an energy input of 100 J/mL or greater, based on volume of the initiator solution; and then, contacting the sonicated initiator solution with a reaction mixture of an isoolefin monomer in an organic diluent to produce the isoolefin homopolymer.

### CROSS-REFERENCE TO RELATED APPLICATIONS

This application claim priority to European patent application EP 20215406.8 filed Dec. 18, 2020, the entire contents of which is herein incorporated by reference.

### FIELD

This application relates to the production of isoolefin homopolymers, for example polyisobutene.

### BACKGROUND

The AlCl₃/H₂O initiating system for polymerizing isoolefin monomers suffers from variability in the activity of the catalyst. This is attributed to differences in the ratio of active species to inactive species, as aluminum trichloride (AlCl₃) is known to form aggregates with itself and with water, which generate inactive species that do not initiate polymerization. Variability in the number of active species changes the number of initiating sites in the polymerization reactor, and if increased suddenly without reducing the catalyst addition to the reactor, can result in low molecular weight product, localized temperature increases and fouling of the reactor. Similar issues with a reactor going cold and the reaction stopping can also occur if the number of active species decreases. Reducing the variability of the catalyst activity for the butyl rubber process can increase capacity by reducing fouling and other issues with the initiator system.

It is known in that cationic initiating systems involving a Lewis acid and an acidic imidazole-based ionic liquid (RmimCl) in the presence of diisopropyl ether can be used to initiate the polymerization of isobutylene to polyisobutylene (I.A. Berezianko et al., Polymer. 145 (2018) 382-390). In such polymerization reactions, it was found that sonicating the initiator system and then adding the monomer stream to the sonicated initiating system improved monomer conversion, but only by 10-20 mol % for AlCl₃ catalyst systems.

There remains a need for reducing variability of catalyst activity in a polymerization process to improve efficiency of a carbocationic polymerization process, especially in processes to produce isoolefin homopolymers such polyisobutene.

### SUMMARY

A process for producing an isoolefin homopolymer comprises: sonicating a solution of an initiator system in an organic solvent, the initiator system comprising a Lewis acid catalyst and a proton source selected from the group consisting of water, an alcohol, a phenol, a thiol, a carboxylic acid or any mixture thereof, to produce a sonicated initiator solution, the sonicating performed at an energy input of 100 J/mL or greater, based on volume of the initiator solution; and then, contacting the sonicated initiator solution with a reaction mixture of an isoolefin monomer in an organic diluent to produce the isoolefin homopolymer.

Sonication of the initiator solution improves catalyst activity, thereby improving conversion of the monomer during production of the isoolefin homopolymer. Variability of the catalyst activity is reduced, thereby increasing overall polymerization reactor capacity, reducing reactor fouling and reducing other issues with the initiator system. Further, simpler initiator systems can be used involving non-ionic proton sources rather than more complicated ionic liquid-based systems.

A major benefit of sonication is to shorten the overall reactor length (residence time) required to achieve a target monomer conversion value (e.g., 85-95 mol %), meaning either that increased flow rates can be achieved through the existing continuous reactors or improved process control can be achieved by ensuring that a consistently high level of monomer conversion near the target value is achieved. In practice, reactors are operated at the highest possible flow rate that can be pushed through the reactor to achieve the target monomer conversion, so having a more active initiator system ensures that the target conversion value is reached and substantially all of the monomer in the feed mixture has reacted.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 is a graph of polymerization reaction time (min:sec) vs. isobutene (IB) conversion (mol %) showing the effect of sonication time for 5 minutes and 10 minutes with 3 mL of an initiator solution in the homopolymerization of isobutene to produce polyisobutene.

FIG. 2 is a graph of polymerization reaction time (min:sec) vs. isobutene (IB) conversion (mol %) showing the effect of sonication time for 5 minutes and 10 minutes with 1.5 mL of an initiator solution in the homopolymerization of isobutene to produce polyisobutene.

FIG. 3 is a graph of sonication energy input (J/mL) vs. isobutene (IB) conversion (mol %) showing the effect of sonication energy input with 0.8 to 1.0 mL of an initiator solution in the homopolymerization of isobutene to produce polyisobutene.

### DETAILED DESCRIPTION

Production of the isoolefin homopolymer involves polymerizing an isoolefin monomer in an organic diluent in the presence of an initiator system (a Lewis acid catalyst and a proton source) capable of initiating the polymerization process. Polymerization occurs in a polymerization reactor. Suitable polymerization reactors include, for example, flow-through polymerization reactors, plug flow reactor, moving belt or drum reactors, and the like. The process may be a continuous or batch process. In a preferred embodiment, the process is a continuous polymerization process. The process may comprise slurry or solution polymerization of the monomers. In a preferred embodiment, the process is a slurry polymerization process.

The isoolefin homopolymer is formed by polymerization of an isoolefin monomer. Thus, the isoolefin homopolymer comprises repeating units derived from the isoolefin monomer. Suitable isoolefin monomers include hydrocarbon monomers having 4 to 16 carbon atoms. In one embodiment, the isoolefin monomers have from 4 to 7 carbon atoms. Examples of suitable isoolefins include isobutene (isobutylene), 2-methyl-1-butene, 3-methyl-1-butene, 2-methyl-2-butene, 4-methyl-1-pentene, 4-methyl-1-pentene and mixtures thereof. A preferred isoolefin monomer is isobutene (isobutylene). A preferred isoolefin homopolymer is polyisobutene.

Suitable organic diluents may include, for example, alkanes, chloroalkanes, cycloalkanes, aromatics, hydrofluorocarbons (HFC) or any mixture thereof. Chloroalkanes may include, for example methyl chloride, dichloromethane or any mixture thereof. Methyl chloride is particularly preferred. Alkanes and cycloalkanes may include, for example, isopentane, cyclopentane, 2,2-dimethylbutane, 2,3-dimethylbutane, 2-methylpentane, 3-methylpentane, n-hexane, methylcyclopentane, 2,2-dimethylpentane or any mixture thereof. Alkanes and cycloalkanes are preferably C6 solvents, which include n-hexane or hexane isomers, such as 2-methyl pentane or 3-methyl pentane, or mixtures of n-hexane and such isomers as well as cyclohexane. The monomers are generally polymerized cationically in the diluent at temperatures in a range of from −120° C. to +20° C., preferably −100° C. to −50° C., more preferably −95° C. to −65° C. The temperature is preferably about −80° C. or colder.

The initiator system comprises a Lewis acid catalyst and a proton source. The catalyst preferably comprises aluminum trichloride (AlCl₃). Alkyl aluminum halide catalysts are also useful for catalyzing the polymerization reaction. Examples of alkyl aluminum halide catalysts include methyl aluminum dibromide, methyl aluminum dichloride, ethyl aluminum dibromide, ethyl aluminum dichloride, butyl aluminum dibromide, butyl aluminum dichloride, dimethyl aluminum bromide, dimethyl aluminum chloride, diethyl aluminum bromide, diethyl aluminum chloride, dibutyl aluminum bromide, dibutyl aluminum chloride, methyl aluminum sesquibromide, methyl aluminum sesquichloride, ethyl aluminum sesquibromide, ethyl aluminum sesquichloride and any mixture thereof. Preferred of alkyl aluminum halide catalysts are diethyl aluminum chloride (Et₂AlCl or DEAC), ethyl aluminum sesquichloride (Et_{1.5}AlCl_{1.5} or EASC), ethyl aluminum dichloride (EtAlCl₂ or EADC), diethyl aluminum bromide (Et₂AlBr or DEAB), ethyl aluminum sesquibromide (Et_{1.5}AlBr_{1.5} or EASB) and ethyl aluminum dibromide (EtAlBr₂ or EADB) and any mixture thereof. A particularly preferred alkyl aluminum halide catalyst comprises ethyl aluminum sesquichloride, preferably generated by mixing equimolar amounts of diethyl aluminum chloride and ethyl aluminum dichloride, preferably in a diluent. The diluent is preferably the same one used to perform the homopolymerization reaction.

Protons are generated from the reaction of the catalyst with the proton sources to produce the proton and a corresponding by-product. The proton source is preferably a non-ionic proton source, for example water (H₂O), an alcohol, a phenol, a thiol, a carboxylic acid or any mixture thereof. Water, alcohol, phenol or any mixture thereof is preferred. The most preferred proton source is water. A preferred ratio of catalyst to proton source is from 5:1 to 100:1 by weight, or from 5:1 to 50:1 by weight. The initiator system is preferably present in the reaction mixture in an amount providing 0.0005-0.02 wt % of the catalyst, more preferably 0.0007-0.008 wt % of the catalyst, based on total weight of the reaction mixture.

The initiator system is dissolved in an organic solvent to produce an initiator solution, which is then contacted with the reaction mixture to initiate polymerization of the monomer. The organic solvent may comprise any of the organic diluents described above. Preferably, the organic solvent comprises a polar organic solvent. Methyl chloride is particularly preferred. The catalyst is preferably present in the initiator solution at a concentration of 0.01 wt % to 0.6 wt %, based on total weight of the initiator solution, more preferably 0.05 wt % to 0.6 wt %, 0.07 wt % to 0.5 wt % or 0.075 wt % to 0.4 wt %. The initiator system is preferably soluble in the reaction mixture.

To improve conversion of monomer to polymer thereby increasing efficiency of the polymerization reaction, the initiator solution is sonicated prior to contacting the initiator solution with the reaction mixture. Sonication of the initiator solution improves catalyst activity thereby improving conversion of the isoolefin monomer during production of the isoolefin homopolymer. In particular, improved conversions are achieved when energy input from sonication is 100 J/mL or greater, based on volume of the initiator solution, preferably 200 J/mL or greater, or 300 J/mL or greater, or 400 J/mL or greater, or 500 J/mL or greater. Preferably, the energy input from sonication is in a range of 100 J/mL to 1500 J/mL, or 200 J/mL to 1200 J/mL, 300 J/mL to 1000 J/mL, 200 J/mL to 700 J/mL, 400 J/mL to 900 J/mL, or 500 J/mL to 800 J/mL. Sonication is performed for a sufficient amount of time to improve catalyst activity. Preferably, the initiator solution is sonicated for 0.5 minutes or more, or 1 minute or more, or 0.5-30 minutes, or 1-30 minutes, or 1-20 minutes, or 1-10 minutes, or 0.5-10 minutes, or 0.5-20 minutes.

Sonication has been found to have no deleterious effects on the initiator system, and no negative impact on the molecular weight of the isoolefin homopolymer. Sonication further permits dissolving the catalyst in the organic solvent at higher concentrations than is possible using standard stirring techniques. Sonication further permits dissolving the catalyst in the organic solvent at lower temperatures (e.g. −80° C. or colder) than is possible using standard stirring techniques.

Sonication of the initiator solution can improve conversion of the monomer in the polymerization reaction by at least 2× in comparison to a polymerization reaction where the initiator solution was not sonicated. In some embodiments, conversion of the monomer is improved to 20 mol % or greater, or even 40 mol % or greater, for example as high as 50 mol %. Monomer conversion can therefore be improved by up to 4× times or more in comparison to monomer conversion achieved without sonication of the initiator solution. In addition, sonication does not impact observed molecular weights of the isoolefin homopolymers produced in the polymerization reaction. The sonicated initiator solution is preferably contacted with the reaction mixture as soon as possible after sonication.

Sonication applies sound energy to agitate particles. Because ultrasonic frequencies (≤20 kHz) are usually used, sonication is also known as ultrasonication or ultra-sonication. Sonicators are generally well known and any suitably powerful sonicator may be used to sonicate the initiator solution. The power of the sonicator and the amplitude of sound waves generated by the sonicator can be suitably selected to provide energy input in the ranges described above and a sonication time that is suitably short while obtaining the desired monomer conversion. If lower amplitude is desires, a longer sonication time may be used, while sonication time may be reduced by using higher amplitudes of the sound waves.

Sonication can be used in conjunction with other methods of improving the performance of the initiator system. For example, the additional use of a tertiary ether (e.g., methyl t-butyl ether (MTBE), ethyl t-butyl ether (ETBE), methyl t-amyl ether (MTAE) and phenyl t-butyl ether (PTBE) or mixtures thereof, especially MTBE) in the initiator solution can have at least an additive effect with sonication in improving polymerization reaction efficiency. The use of tertiary ethers for improving initiator systems is described in International Patent Publication WO 2020/124212 published Jun. 25, 2020, the entire contents of which is herein incorporated by reference.

After the polymerization is complete, the isoolefin homopolymer may be recovered from the reaction mixture by known methods. For example, the organic diluent, organic solvent and residual monomer may be separated from the isoolefin homopolymer by flash separation using a heated organic solvent or steam. The isoolefin homopolymer may then be dried and processed into cements, crumbs, bales or the like for further use, storage or shipping.

### EXAMPLES

### Initiator Solution Preparation

0.15 g of AlCl₃ (99.99% purity) was added to 100 mL of liquid MeCl at −30° C. in a 125 mL Erlenmeyer flask, all inside an MBraun™ glovebox filled with nitrogen and equipped with liquid nitrogen cooled pentane baths. The mixture was stirred at approximately 300 rpm using an overhead stirrer for 45 minutes. The solution was then cooled to −95° C. and transferred to a 250 mL round bottom with a 45/50 joint. The solution contained a small amount of water as a proton source, the water being present as an impurity in the MeCl in an amount of about 15-50 ppmv.

To prepare sonicated initiator solutions, the initiator solution as prepared as described above was sonicated using a horn sonicator (QSonica™, 500 Watts, 20 KHz) for a desired period of time (periods of 5 minutes and 10 minutes) and an amplitude level of 50% of full horn movement to produce the sonicated initiator solution.

### Polymerization Reaction

Unsonicated and sonicated initiator solutions were then used to prepare polyisobutene by adding the sonicated initiator solution to a mixture of isobutene in methyl chloride as follows.

Methyl chloride (MeCl) and isobutene (IB) at −96° C. were added to a reactor that was cooled to −96° C. The reaction mixture was then cooled to about −91° C. with stirring at 800 rpm. Then, a desired volume of the initiator solution was added in a manner to provide good initiation without a high temperature increase of the reaction mixture.

During polymerization, the reaction was monitored using an immersion Raman spectrometer to measure conversion of isobutene.

The polymerization reaction was then quenched after 5 minutes by adding to the reaction mixture 1 mL of a solution of 1 wt % NaOH in ethanol. The reaction was terminated if the temperature of the reaction mixture increased by more than 20° C. before the end of 5 minutes. The reactor was then removed from the glovebox and 1 mL of dilute antioxidant solution (1 wt % Irganox™ 1076 in hexanes) was added, along with further hexanes to dilute the reaction mixture. The methyl chloride was allowed to evaporate overnight to form a polyisobutene cement in hexanes. The polyisobutene was then coagulated from the hexane cement using ethanol and dried overnight at 60° C. under vacuum.

### Example 1: Controls

Polymerization reactions to produce polyisobutene were conducted as described above using 3 mL of initiator solutions that were not sonicated or were sonicated at the same sonication energy input for 5 minutes or 10 minutes. The amount of initiator solution is an excess for the polymerization reaction; therefore isobutene (IB) conversions are expected to be 100 mol % whether or not the sonication was performed on the initiator solution.

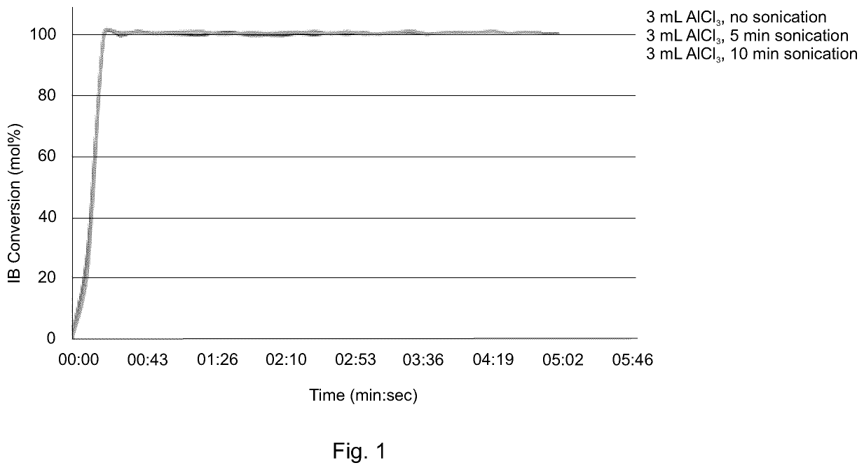

As seen in FIG. 1, IB conversion was about 100 mol % for the unsonicated initiator solutions as well as for the initiator solutions sonicated for 5 minutes and 10 minutes.

### Example 2: Effect of Sonication Time on Monomer Conversion

Polymerization reactions to produce polyisobutene were conducted as described above using controls in which 3 mL and 1.5 mL of unsonicated initiator solution was used. To see the effect of sonication, polymerization reactions to produce polyisobutene were also conducted in which the initiator solution was sonicated at the same sonication energy input for 5 minutes or 10 minutes.

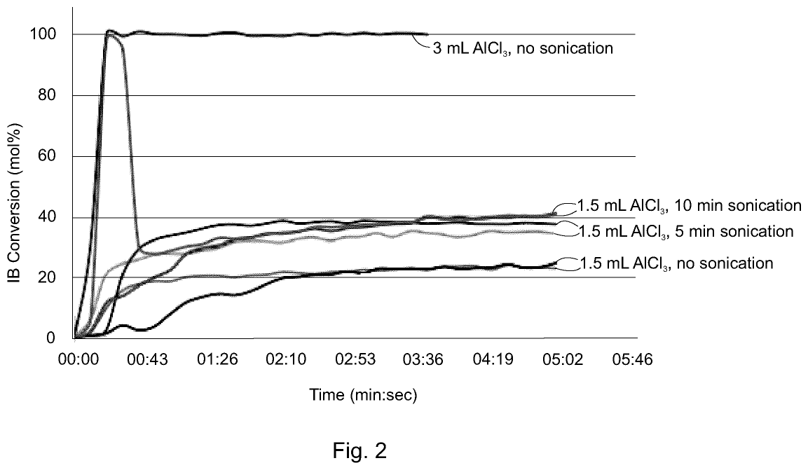

FIG. 2 shows the effect on isobutene (IB) conversion of sonication times at 5 minute and 10 minutes with 1.5 mL of an aluminum trichloride initiator system. The results were compared to isobutene (IB) conversion resulting from Control polymerization reactions in which 1.5 mL and 3 mL of unsonicated initiator solution were used. The 1.5 mL Control provided an IB conversion of about 22 mol %, whereas 1.5 mL of the initiator solution sonicated for 5 min provided an IB conversion of about 35 mol %, and sonication for 10 min resulted in an IB conversion of about 40 mol %. Thus, sonicating the initiator solution improves IB conversion and allows for the use of less initiator solution.

### Example 3: Effect of Sonication Energy Input on Monomer Conversion

Polymerization reactions to produce polyisobutene were conducted as described above using initiator solutions that are sonicated to achieve sonication energy inputs ranging from 100-400 J/mL in increments of 100 J/mL and are compared to a polymerization reaction where the initiator solution is not sonicated (i.e., 0 J/mL). Sonication energy input was normalized to Joules per mL of initiator solution to provide an indication of whether sonication energy affects monomer conversion.

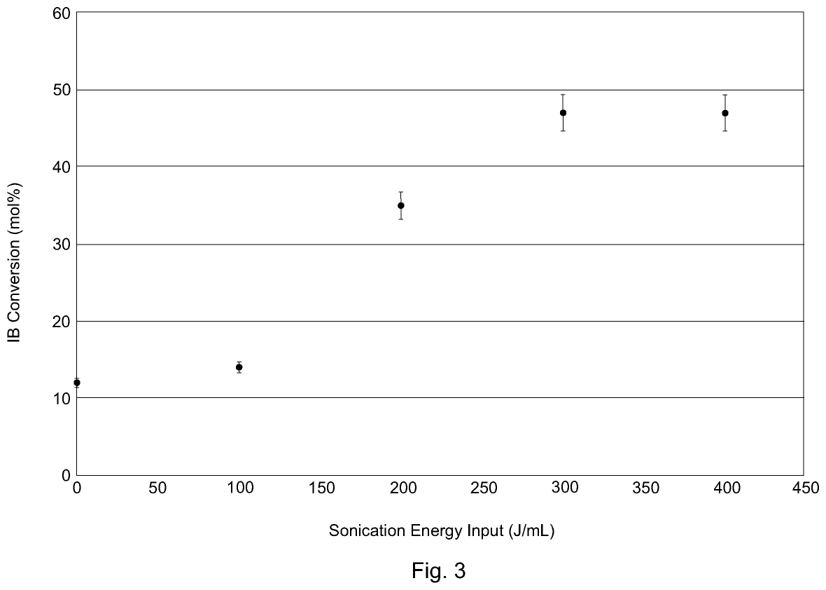

As seen in FIG. 3, as sonication energy input increases, isobutene (IB) conversion increases beyond the IB conversion that results from an unsonicated initiator solution until a maximum conversion is reached. Sonication can therefore improve monomer conversion depending on the sonication energy input. At 100 J/mL sonication energy input, the IB conversion increased to 14 mol % from 12 mol % when no sonication is employed. A very large increase in IB conversion to 35 mol % is realized at a sonication energy input of 200 J/mL. The IB conversion plateaus at 47 mol % when the sonication energy input reaches 300 J/mL.

The novel features will become apparent to those of skill in the art upon examination of the description. It should be understood, however, that the scope of the claims should not be limited by the embodiments, but should be given the broadest interpretation consistent with the wording of the claims and the specification as a whole.

What is claimed is:

1. A process for producing an isoolefin homopolymer, the process comprising:
sonicating a solution of an initiator system in an organic solvent, the initiator system comprising a Lewis acid catalyst and a proton source selected from the group consisting of water, an alcohol, a phenol, a thiol, a carboxylic acid or any mixture thereof, to produce a sonicated initiator solution, the sonicating performed at an energy input of 100 J/mL or greater, based on volume of the initiator solution; and then,
contacting the sonicated initiator solution with a reaction mixture of an isoolefin monomer in an organic diluent to produce the isoolefin homopolymer.

2. The process of claim 1, wherein the energy input is 200 J/mL or greater.

3. The process of claim 1, wherein the energy input is in a range of 100 J/mL to 1500 J/mL.

4. The process of claim 5, wherein the energy input is in a range of 200 J/mL to 700 J/mL.

5. The process of claim 1, wherein in sonication is performed for 0.5 minutes or more.

6. The process of claim 4, wherein in sonication is performed for 1-10 minutes.

7. The process of claim 1, wherein the organic solvent comprises methyl chloride.

8. The process of claim 1, wherein the Lewis acid catalyst is present in the initiator solution at a concentration of 0.01 wt % to 0.6 wt %, based on total weight of the initiator solution.

9. The process of claim 1, wherein the initiator system is present in the reaction mixture in an amount of 0.0005-0.02 wt %, based on total weight of the reaction mixture.

10. The process of claim 1, wherein the Lewis acid catalyst and the proton source are present in the initiator system in a ratio of from 5:1 to 50:1 by weight.

11. The process of claim 1, wherein the Lewis acid catalyst comprises aluminum trichloride.

12. The process of claim 1, wherein the proton source comprises water.

13. The process of claim 1, wherein the initiator system is soluble in the reaction mixture.

14. The process of claim 1, wherein the organic diluent comprises methyl chloride.

15. The process of claim 1, wherein the isoolefin monomer is isobutene.

16. The process of claim 1, wherein the process is a slurry process, the process is a continuous process or the process is both a slurry process and a continuous process.

17. The process of claim 6, wherein
the organic solvent comprises methyl chloride;
the Lewis acid catalyst is present in the initiator solution at a concentration of 0.01 wt % to 0.6 wt %, based on total weight of the initiator solution; and
the Lewis acid catalyst and the proton source are present in the initiator system in a ratio of from 5:1 to 50:1 by weight.

18. The process of claim 17, wherein
the initiator system is present in the reaction mixture in an amount of 0.0005-0.02 wt %, based on total weight of
the reaction mixture; and
the Lewis acid catalyst comprises aluminum trichloride.

19. The process of claim 18, wherein
the proton source comprises water;
the initiator system is soluble in the reaction mixture;
the organic diluent comprises methyl chloride; and
the isoolefin monomer is isobutene.

20. The process of claim 19, wherein the process is a continuous process.
